(19) United States
(12) Patent Application Publication
(10) Pub. No.: US 2006/0230030 A1
(43) Pub. Date: Oct. 12, 2006

(54) Method and system for accessing and viewing files on mobile devices

(76) Inventors: Peter J. Volpa, Hammonton, NJ (US); Retta L. Volpa, Hammonton, NJ (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/104,127

(22) Filed: Apr. 12, 2005

(51) Int. Cl. G06F 7/00

(52) U.S. Cl. 707/3; 709/219; 709/217; 709/203; 709/215

(57) ABSTRACT

A system for downloading files to a hand-held device includes a file converter for converting a selected file to a distilled file. The file converter uploads the distilled file to a server, which is associated with a file processor. The server processes the distilled file and sends it to a hand-held device. A file viewer displays or plays the distilled file on the hand-held device. A method for sharing files on a data storage device with a hand-held device includes the steps of selecting a file on the data storage device to be shared with the hand-held device, processing the selected file on the data storage device into a converted format for uploading to a server, uploading the converted file to the server, accessing the server from the hand-held device, and sending the converted file to the hand-held device for displaying or playing on the hand-held device.

### FIELD OF THE INVENTION

The present invention relates to systems for remotely accessing computer files, and particularly to a system and method for selecting computer files on an office network or the like, and efficiently transferring the selected computer files to a mobile device for displaying or playing the files on the mobile device.

### BACKGROUND

Business people are becoming increasingly dependent on computer technology to conduct their business. Computer software allows information and data to be saved in a variety of formats, including word processing documents, spreadsheet files, presentation files and image files. Businesses often store computer files on a central file server that can be accessed by one or more computer workstations connected with the file server in a local area network.

Many individuals spend significant time doing work outside of the office. The emergence of lap top computers, in particular, has allowed business people to do more work outside of the workplace, and spend less time in the office. Individuals working outside of the office access computer files stored on their office's network from their laptop computers. Laptop computers are a suitable means for accessing office files, but are relatively large and heavy. To operate the laptop computer, the person must be able to rest the laptop computer on their laps, a counter top, or other stable work surface. This may not be possible when the person is standing in line, walking to a meeting, or engaged in other activity that preclude opening the laptop computer. Laptop computers also consume a significant amount of power and have a limited battery life. Moreover, the screen size of many laptop computers is relatively large and does not offer much privacy when the user is viewing confidential files on planes, trains, waiting areas, and other crowded environments. As a result, the laptop computer is not always an ideal means for quickly accessing a file and viewing the file from a remote location.

Portable hand-held devices (or “mobile devices”), such as mobile phones and PDAs, are much smaller and lighter than laptop computers. They are easily carried, and can be turned on with little effort. Portable hand-held devices require very little space to operate, since they can be operated in the palm of one's hand. They typically offer a longer battery life than laptop computers, and allow a person to operate them in almost any environment. Moreover, the screen size on hand-held devices is much smaller than the screen size of laptop computers, offering privacy in crowded environments. As a result, there is a growing desire to use portable hand-held devices for accessing and viewing files, as opposed to laptop computers. It would be particularly desirable to provide an operable system and method for use in enabling cell phones to conveniently access, edit and view computer files.

### SUMMARY OF THE INVENTION

The foregoing concerns are addressed by the present invention, which provides a method and system for accessing and viewing files on a portable hand-held device and, particularly, on a cell phone. The invention may be used to access and download a variety of file types, including but not limited to ASCII text files, word processing documents, spreadsheets, image files, presentation files, movie files and audio files. In a first aspect of the invention, a method for sharing files on a data storage device, such as a personal computer, with a hand-held device, such as the cell phone, includes the steps of selecting a file on the data storage device to be shared with the hand-held device, processing the selected file on the data storage device into a converted format for uploading to a web server, uploading the converted file to the web server, accessing the web server from the hand-held device; and sending or downloading the converted file to the hand-held device for displaying or playing on the hand-held device.

In a second aspect of the invention, a system for sharing a file stored on a data storage device with a hand-held device is provided. For this purpose, a file converter converts the selected file on the data storage device to a distilled file and then uploads the distilled file to a web server. A file processor associated with the web server processes the distilled file and sends the distilled file to the hand-held device for viewing. A file viewer associated with the hand-held device downloads the distilled file from the web server and displays ir plays the distilled file on the hand-held device.

In a third aspect of the invention, a system for downloading and viewing files on a hand-held device includes a data storage device having access to the Internet and a web server. The web server communicates with the data storage device through an Internet connection established on the data storage device. A file converter processes a selected file on the data storage device into a distilled file and uploads the distilled file to the server. The server includes a file processor that receives the distilled file from the data storage device. The system also includes a hand-held device with one or more components for displaying or playing files. The hand-held device has access to the Internet and includes a file viewer. The file viewer accesses the server through an Internet connection established on the hand-held device. The file viewer displays or plays the distilled file on the hand-held device.

In a fourth aspect of the invention, a system for downloading and viewing files on a mobile device includes a data storage device having access to the Internet and a server. The server communicates with the data storage device through an Internet connection established on the data storage device. A file converter processes a selected file on the data storage device into a distilled file and uploads the distilled file to the server. A file sharer converts the distilled file on the server to a web page. A hand-held device comprising an Internet connection includes a file viewer adapted to download the web page to the hand-held device.

### DESCRIPTION OF THE DRAWINGS

The foregoing summary as well as the following description will be better understood when read in conjunction with the figures in which:

FIG. 1 is a diagram of components of a first system for retrieving and viewing files in accordance with the present invention.

FIG. 2 is a diagram of elements that may be used in the system of FIG. 1, illustrating elements for converting, processing and viewing files.

FIG. 3 is a block diagram illustrating an overview of a first method of retrieving and viewing files in accordance with the present invention.

FIG. 4 is a block diagram illustrating steps for processing files on a data storage device in accordance with the present invention.

FIG. 5 is a block diagram illustrating steps for processing files on a web server in accordance with the present invention.

FIG. 6 is a block diagram illustrating steps for accessing a web server from a hand-held device and downloading files onto a hand-held device in accordance with the present invention.

FIG. 7 is a diagram of components in a second system for retrieving and viewing files in accordance with the present invention.

FIG. 8 is a block diagram illustrating steps in a second method for retrieving and viewing files in accordance with the present invention.

FIG. 9 is a diagram of components in a third system for retrieving and viewing files in accordance with the present invention.

FIG. 10 is a block diagram illustrating steps in a third method for retrieving and viewing files in accordance with the present invention.

### DETAILED DESCRIPTION OF THE PREFERRED EMBODIMENT

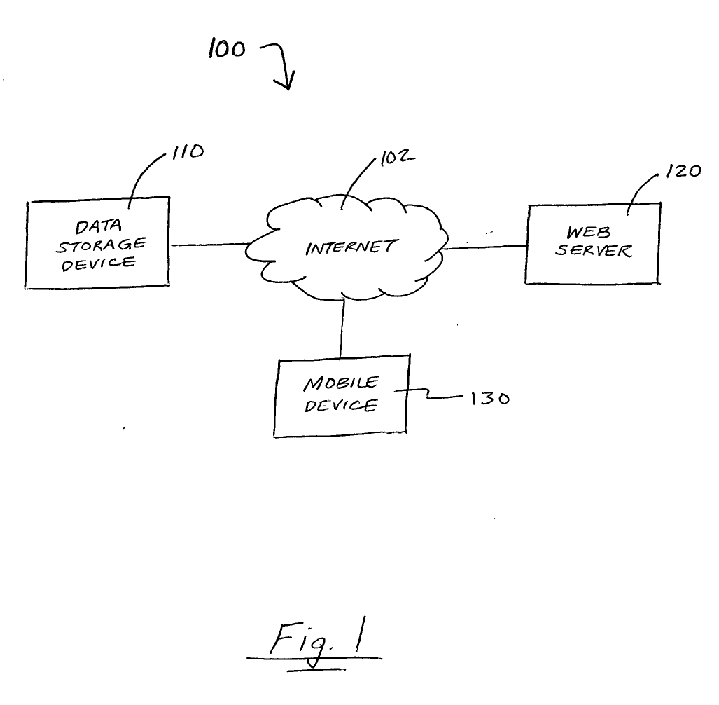

Referring to the drawing figures in general, and to FIG. 1 specifically, a system 100 for accessing files on a hand-held device, such as a cell phone, is shown schematically in accordance with the invention. The system 100 includes a data storage device 110, which may be a desktop computer, laptop computer or other similar device. The system 100 converts files on the data storage device 110 and transfers the converted files to a hand-held device 130. The hand-held device may be a cell phone, PDA or other portable hand-held device. The system 100 includes client software on the data storage device 110 that converts a selected file on the data storage device into a reduced-size file, or “distilled file”. Conversion of files into distilled files reduces the amount of data that is ultimately downloaded to the hand-held device. This allows portable hand-held devices with limited memory, such as cell phones, to download files quickly and readily display or play the files. The invention may be used to access, display or play a variety of different file types on a hand-held device, including but not limited to ASCII text files, word processing documents, spreadsheets, image files, presentation files and movie files. In addition, the invention may be used to access, play or listen to a variety of files with sound on the hand-held device, including but not limited to movie files and audio files.

The term “distilled file” generally refers to a file that has been processed to reduce the amount of data contained in the file. Files may be processed into distilled files in a number of ways in accordance with the present invention. For example, the files may be processed to remove some or all of the non-essential formatting attributes that control the appearance of information in the file. If the document is a word processing document, the document may be converted into a distilled file by removing tab sets, margins, line spacing, paragraph formatting and font information. If the document is an image file, the file may be converted into a distilled file by reducing the number of colors contained in the image, or by reducing the quality of the image in other ways. Other attributes of files may be removed, depending on the user's need to retain characteristics in the original file and the limitations imposed by the memory and processing capability of the hand-held device. By processing files on the data storage device before the transfer of such files to the hand-held device, the resources of the hand-held device can best be preserved and utilized.

The system 100 converts computer files on the data storage device 110 to distilled files and uploads the distilled files to a web server 120. The data storage device 110 is connected with the Internet 102 and communicates with the web server 120 through an Internet connection. The hand-held device 130 is also connected with the Internet 102 and accesses the web server 120 through the Internet connection. After a distilled file is uploaded to the web server 120, the user of the hand-held device 130 logs in to the web server to download the distilled file to the hand-held device.

The system 100 is operated in large part by software installed on the data storage device and the hand-held device in conjunction with the operative software of the web server. Software installed on the data storage device performs tasks related to, among other things, processing files and uploading the processed files to the web server. Software on the web server performs tasks related to, among other things, storing the converted files and controlling access to the files. Software installed on the hand-held device performs tasks related to, among other things, downloading files from the server, processing the downloaded files, and displaying or playing the files.

For convenience of operation, the system 100 converts computer files to distilled files on the data storage device 110. The files may also be converted on the web server 120, but there are certain advantages to converting files on the data storage device 110, before the files are uploaded to the server. For example, by converting files on the data storage device 110, rather than the web server 120, the web server does not become burdened with data processing tasks. If the web server 120 performs the data processing, the server may form a “bottleneck” in the event that a large number of data storage devices upload files to the web server for conversion at the same time. Converting files on the data storage device 110 also avoids uploading large files to the web server 120 for conversion, which can take significant time and consume a large amount of bandwidth.

The data storage device 110 is also preferred because the data storage device is likely to have more application programs that assist the file conversion process. Computer files in a proprietary format, like Microsoft Word and Excel documents, must be converted to a non-proprietary format before they can be efficiently uploaded to the server. Files in proprietary format are more accurately converted to a non-proprietary format if the files are converted using the applications that create them. In most cases, the applications used to create files are installed on the data storage device 110, rather than the web server 120. Therefore, the system 100 performs file conversion on the data storage device 110, where the creating applications are installed.

The system 100 converts large computer files into a group of smaller page files. The page files, which represent sections or portions of the original file, are downloadable and viewable individually on the hand-held device 130. This allows the user to select specific parts of a file for viewing, without having to download the entire file. Processing large files into smaller page files further reduces the amount of data transmitted to the hand-held device 130, increasing the speed of downloading files to the hand-held device.

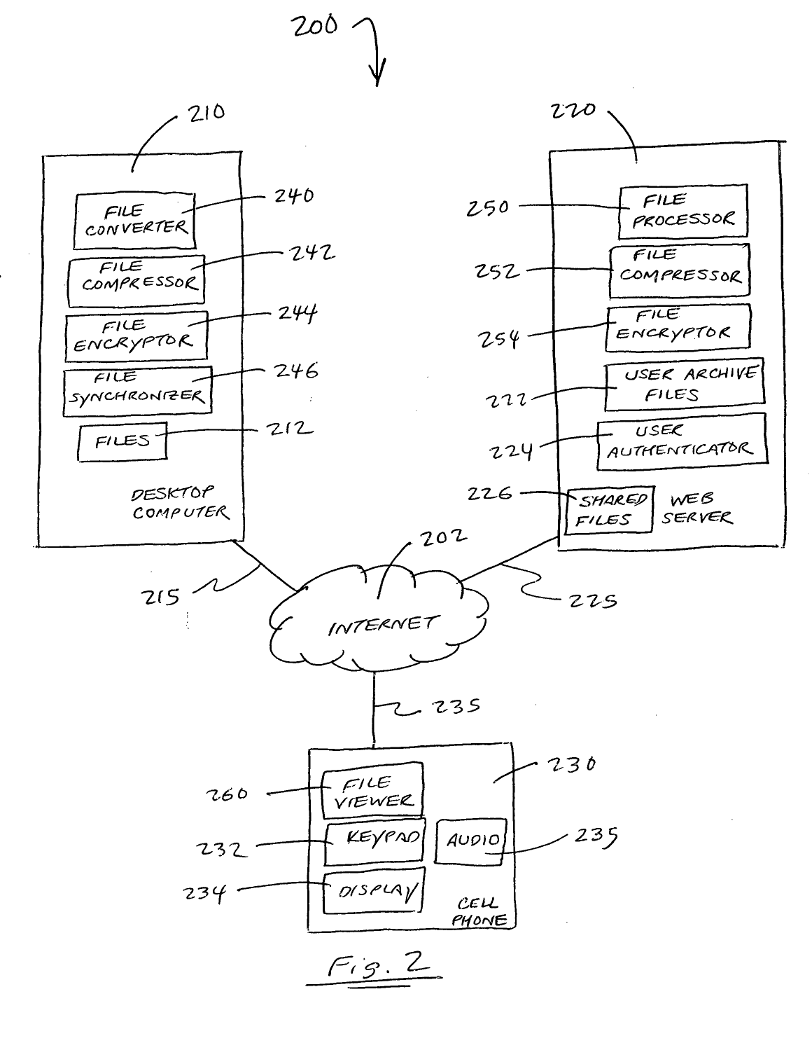

The present invention will now be described in greater detail with reference to FIG. 2, which shows a system 200 that includes a data storage device 210, a web server 220 and a hand-held device 230. For purposes of description and clarity, the system 200 will be described with one data storage device, a desktop computer 210, and one hand-held device, such as a cell phone 230. It should be understood that the system 200 may be used with a large number of data storage devices and hand-held devices with access to the web server 220. In addition, the system 200 may be used with a variety of data storage devices and hand-held devices.

The desktop computer 210 stores a number of computer files 212 that can be uploaded to the web server 220. The desktop computer 210 is connected with the Internet 202 by an Internet connection 215. The Internet connection 215 may be a DSL connection, wireless router, dial-up modem, or other means for connecting to the Internet. The web server 220 communicates with the desktop computer 210 through an Internet connection 225. The link between the server 220 and desktop computer 210 allows files on the desktop computer to be uploaded to the web server. The cell phone 230 has an Internet connection 235 configured to access the web server 220. The cell phone 230 includes client software that allows the user of the cell phone to download files from the web server 220 and view them on the cell phone.

The desktop computer 210 includes a file converter 240 for processing files into a distilled format for uploading to the web server 220. The file converter 240 processes files on the desktop computer 210. During processing, the file converter 240 strips out non-essential data from the original file. For example, the file converter 240 may be operated to remove non-essential formatting attributes from the original file. After files are converted to distilled files, they may be uploaded from the desktop computer 210 onto the web server 220.

The web server 220 includes a file processor 250 that receives files uploaded from the desktop computer 210 and stores the files. The file processor 250 may store files on the web server 220 in a variety of ways. In the system 200 in FIG. 2, the file processor 250 stores uploaded files in a user archive file or folder 222 that can be accessed from the cell phone 230. The cell phone 230 includes a file viewer 260 that communicates with the file processor 250 to download and view files. The file viewer 260 enables selection of files on the web server 220 for downloading and viewing on the cell phone 230. The cell phone 230 has a key pad 232 that allows the user to log on to the web server, access a user archive file on the web server, and select files in the user archive file for downloading. The cell phone 230 also has a display screen 234 and an audio speaker 235 for displaying and/or playing files downloaded from the web server 220.

System 200 may be divided into three general areas or stages of operation: (1) file conversion, (2) file processing and (3) file viewing. Each of these stages will be described in detail below.

File Conversion

File conversion preferably takes place on the desktop computer 210. The file converter 240 is configured to operate with the Microsoft Windows Operating System, but may be adapted to function in other operating systems. In the Microsoft Windows environment, the file converter 240 may include a dialog box that enables the user to search through directories and subdirectories on the desktop computer and select files to be uploaded to the web server 220. The dialog box also enables the user to search for files on a shared network, an internal disk drive, or external device, such as a digital camera or zip drive. The file converter 240 may also include a drag-and-drop feature that allows the user to select a file for uploading by clicking on a file icon and dragging the icon into the window where the file converter is running. Once a file is selected for uploading, the file converter 240 automatically converts the file to a distilled file.

The file converter 240 converts files that are saved in non-proprietary and proprietary formats. Files in non-proprietary formats may be converted directly by the file converter 240. Files in proprietary format are converted by a process in which the file converter 240 interacts with the application that created the file (“source application”). In general, files in proprietary format are converted most accurately when the source application is used in the conversion process.

To convert a file in proprietary format, the file converter 240 utilizes the Application Programming Interface (API) exposed by the source application and extracts information from the file stored in proprietary format. The file converter 240 then saves the extracted information in a distilled file. Proprietary formats that are compatible with the file converter 240 in system 200 may include, but are not limited to, Microsoft® Word, Microsoft® Excel, Microsoft® PowerPoint, Corel WordPerfect®, Corel Quattro Pro® and Corel Presentations™.

The file converter 240 extracts different types of information from files depending on the type of files being converted. For word processing documents, the file processing software 240 extracts the full text, along with a set of attributes for the text. The text attributes include, but are not limited to, bold, italic, underline, double underline, strikethrough, foreground color, background color, and justification. Each page in the word processing document is saved as a separate page file. Attributes that are not desired may be stripped from the document or file to conserve communications bandwidth and the potentially limited processing capability of the hand-held device.

For spreadsheet documents, the text in each cell is retrieved, along with a set of attributes for the text. The text attributes include, but are not limited to, bold, italic, underline, double underline, strikethrough, foreground color, background color, justification, text wrap and vertical alignment of text in the cell. In addition to the cell text and text attributes, the number of rows and columns in the spreadsheet and the width of each column is obtained. In spreadsheet files containing multiple sheets, each sheet is saved as a separate page file. Titles or names assigned to any sheets are also retrieved and saved, as will be described in more detail below. Tables that are embedded in word processing documents are handled in the same manner as spreadsheets. For presentation files containing one or more slides, the file converter 240 extracts each slide as an image, and the title of each slide as text. The file converter 240 saves each slide as a separate page file. Again, any attributes that are not desired may be stripped from the document or file.

Image files, regardless of original file format, are converted by the file converter 240 to a selected format such as Portable Network Graphics (PNG) format or Joint Photographic Experts Group (JPG) format. The file converter 240 scales the image file to fit the screen of the hand-held phone. Scaling options include 25%, 50%, 100%, 200% and 400%, but may include other scaling values to accommodate a specific hand-held device and the desired amount of detail to display on the hand-held device. The file converter also includes features for rotating images to best fit the screen of the hand-held device, converting images to grayscale and sharpening images.

The conversion of files will now be described in greater detail. For word processing documents, text and text attributes are extracted by the file converter 240. Converted word processing files typically consist of a series of pages. Each page consists of a series of blocks, with each block containing one or more text attributes and text. The text attributes are described using an ASCII format. Blocks consist of a “less than” symbol followed by one or more attributes. Attributes are separated by semi-colons. The last attribute in the list is followed by a “greater than” symbol. “ESC” represents an ASCII ESC character (1Bh) that separates the attribute list from the text in the block. The contents of a block may appear in the following arrangement:

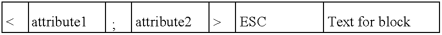

where “attribute1” represents a first attribute (or first text attribute), “attribute2” represents a second attribute (or second text attribute), and “Text for block” represents a set or block of data, such as text, having the first and second text attributes. A document will have at least one page with one block designating attributes and text. Attributes control the appearance of the data or text for either the remainder of the document or until another text attribute controlling the same feature is encountered in the code.

Table 1 contains a list of text attributes that may be extracted during file conversion, along with text attribute codes that may be used in the converted file:

TABLE 1
List of Text Attributes and Corresponding Codes

| Attribute | Code for ON | Code for OFF |
|---|---|---|
| Bold | SB1 | SB0 |
| Italic | SI1 | SI0 |
| Underline | SU1 | SU0 |
| Double Underline | SU2 | SU0 |
| Strikethrough | SS1 | SS0 |
| Align left | AL | — |
| Align center | AC | — |
| Align right | AR | — |
| Wrap text | WP1 | WP0 |
| Table | ST1 | ST0 |
| Align top | AT | — |
| Align middle | AM | — |
| Align bottom | AB | — |
| Foreground color | FGn | — |
| Background color | BGn | — |

The attributes and codes listed in Table 1 are applicable to the conversion of word processing documents and spreadsheets. Some of the attributes are only used when working with spreadsheets and others are used only for word processing documents. Align top (AT), Align middle (AM), Align bottom (AB) and Wrap text (WP) are spreadsheet attributes. Table (ST) is a word processing attribute. Foreground and background colors are determined by the attribute designator followed by a number (n) specifying the index into a color table.

The converted file format for spreadsheet documents is similar to that for word processing documents. The spreadsheet format is organized as ASCII LF character (0Ah) delimited rows. Each row is made up of ASCII ESC character (1Bh) delimited columns. Each cell is converted into a modified block attribute scheme. Blocks include a “less than” symbol followed by one or more attributes. Attributes are separated by semi-colons. The last attribute in the list is followed by a “greater than” symbol. The contents of a block may appear in the following arrangement:

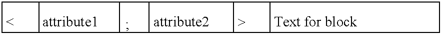

where “attribute 1” represents a first attribute (or first text attribute), “attribute2” represents a second attribute (or second text attribute), and “Text for block” represents a set or block of data such as text, having the first and second text attributes.

The first line in the converted spreadsheet format contains column information. Column widths (i.e. the number of characters that fit on a single line in a column) are expressed as an integer. The first line contains a column width for every column in the spreadsheet. Therefore, the number of column width values equals the number of columns in the spreadsheet. Each column width value is separated by an ASCII ESC character (1Bh). Each line in the converted format is terminated with a line feed (LF) character.

### EXAMPLES

(1) The first line in the converted file for a spreadsheet having 5 columns that are each 10 characters wide would be described as:

10(ESC)10(ESC)10(ESC)10(ESC)10(LF)

(2) A spreadsheet having 2 columns each 15 characters wide, showing a list of states and corresponding state populations with different background colors would appear as:

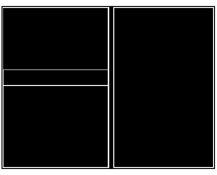

The converted block description for the spreadsheet would be:

15(ESC)15(LF)
<BG29;AL>Alabama (ESC)<BG35;AR>4,447,100(LF)
<BG30;AL>Alaska (ESC)<BG35;AR>626,932(LF)
<BG22;AL>Arizona (ESC)<BG35;AR>5,130,632(LF)
<BG36;AL>Arkansas (ESC)<BG35;AR>2,673,400(LF)
<BG32;AL>California (ESC)<BG35;AR>33,871,648(LF)
<BG32;AL>California (ESC)<BG35;AR>33,871,648(LF)
<BG37;AL>Colorado (ESC)<BG35;AR>4,301,261(LF)
<BG33;AL>Connecticut (ESC)<BG35;AR>3,405,565(LF)
<BG29;AL>Delaware (ESC)<BG35;AR>783,600(LF)

where “BGxx” refers to a background color, “AL” refers to left alignment of text, and “AR” refers to right alignment of text.

The system 200 can be used to download and view files having multiple pages or sheets. Files with multiple pages or sheets may be relatively large files and contain a significant amount of data, even after the removal of non-essential formatting attributes. In most cases, files with multiple pages contain too much data to be stored in the limited memory of the cell phone. To reduce the amount of data transferred per file, the file converter 240 processes individual pages and sheets of multiple page documents, and saves each page or sheet as a separate “page file.” This feature allows the user of the cell phone 230 to download and view individual pages in a long document, without having to download the entire file. Downloading the entire file may take very long, and may not be possible on many hand-held devices with limited memory.

The file converter 240 can save page files with file names that help identify the document and page associated with the file. Page files are saved under a base filename, which may be the original filename of the file prior to conversion. The file converter 240 adds a multi-digit reference number to the base filename. The reference number represents the order and position of the page file in the original file, relative to other page files. Accordingly, the file converter 240 may add the reference number “01” to the first page file, “02” to the second page file, and so on. The multi-digit number may have two or more digits followed by a leading period. The file converter 240 also adds a document type extension preceded by a period. After the converted file is sent to the hand-held device, the hand-held device interprets the document type extension and displays an icon on the display screen to notify the user of the type of document being downloaded.

For illustration purposes, the following filenames may be generated for page files derived from the first, second and third pages of a Microsoft Word document having an original filename of “WinterSales.doc”:

WinterSales.01.doc

WinterSales.02.doc

WinterSales.03.doc

The system 200 may use data compression to further reduce the size of files prior to uploading the files to the web server 220. Referring to FIG. 2, the desktop computer 210 includes a file compressor 242 operable to compress files before the files are uploaded to the web server 220. Once the files are converted and divided into page files, the file compressor 242 saves each converted file in a compressed archive file format, such as a ZIP archive file. The ZIP file format is a compressed archive that supports multiple archived files and comment fields associated with each file.

The file compressor 242 can add page identifiers or labels to each file in the compressed archive file. The page identifiers are incorporated into the comment fields in the compressed archive file to identify individual files stored in the compressed archive file. The comment fields may be downloaded with the list of corresponding files to the cell phone 230 to allow the user to identify and distinguish the downloadable files. For word processing documents, the page identifier has the format “Page n”, where n represents the page number of the page saved in the page file. For page files derived from spreadsheets, the page identifier includes the label on the sheet. For page files derived from presentation files, the label incorporates the title used on the slide. If the slide does not have a title, the file compressor 242 may be configured with a default setting that assigns a generic label, such as “Slide n”, to the page file, where n refers to the slide number.

The system 200 may also use data encryption to send files in a secure format to the web server 220 and cell phone 230. The desktop computer 210 includes a data encrypter 244 that encrypts compressed archive files. Encryption is done in the context of file uploading and involves interaction between the file converter 240 and the file processor 250. The desktop computer 210 logs on to the web server 220, at which time the file processor 250 returns a unique number to the desktop computer called a nonce. The nonce is a cryptographically strong pseudorandom 128-bit number. The nonce value is used in conjunction with a 128-bit key to encrypt any data sent to the web server 220.

Data encryption uses the Twofish block cipher in output feedback mode (OFB). The nonce is used as the initialization vector (IV) and insures that if the same data happens to be sent more than once, the resulting encrypted data will always be different. The Twofish cipher encrypts in 128-bit blocks. The system uses a 128-bit key with a 128-bit IV. Output feedback mode effectively turns the block cipher into a stream cipher and removes the normal requirement that the data size be a multiple of the block size.

The 128-bit key used for encryption is the same as an intermediate value used for authentication (and described in RFC 2617). The key is computed as the first 128-bits of the SHA1 hash of the user's account number (hand-held phone number) concatenated with a colon (‘:’) and the user's password:
Key=First128Bits(SHA1(account+‘:’+password))

The system 200 has an optional synchronizing feature that may optionally update files on the web server 220 as they become modified on the desktop computer 210. In FIG. 2, the desktop computer 210 includes a file synchronizer 246. After the desktop computer 210 uploads a file to the web server 220, the file synchronizer 246 checks the desktop computer on a regular basis for any changes to the original document. If the original document is modified, the file converter 240 may automatically convert the modified document and upload it to the server 220 to replace the previously uploaded version. The converted file may also be compressed and encrypted in the manner described earlier, prior to being uploaded to the web server 220. This keeps files on the desktop computer 210 in sync with files on the web server 220, allowing the hand-held device 230 to download the current version of a file. The synchronizer 246 may be enabled to automatically update all files, or specific files that are selected for updating. The file updating option may be selected on the desktop computer 210 as each file is selected for uploading.

The file synchronizer 246 may be operated manually by the user to remove files from the user's archive file on the web server 220. For example, a user who uploads a file to the web server 220 and later deletes the original file from the desktop computer 210 may wish to remove the uploaded file from the web server. The user selects one or more file names and enters a command on the desktop computer to delete the file or files from the web server 220. The desktop computer 210 sends a list to the web server 220 containing the names of files to be deleted from the server. Any files in the list will be removed from the web server 220.

In some cases, a user on the system 200 may desire to upload files to the web server 220 to share with multiple users of the system 200. The desktop computer 210 is configured to send file sharing information to the web server 220 to allow multiple hand-held devices to download and view the uploaded files. When files are uploaded to the web server 220, the desktop computer 210 sends information to indicate which of the uploaded files are selected by a user to be shareable files. The desktop computer 210 also sends the web server 220 a list of user accounts on the web server that may share the uploaded documents (called a “shared list”). The user may select user accounts for their shared list from the desktop computer 210, prior to uploading files to the web server 220.

Both the desktop computer 210 and the cell phone 230 are configured to send and receive client profile information associated with a specific user account. Client profile information may include a user-friendly folder name to be assigned to the user's archive folder on the web server 220. For example, the user may set up an account that uses the user's name as the folder name. When the user successfully accesses the server 220 from the cell phone 230, the server 220 sends a document list with a banner or label at the top of the list containing the user's name. This is useful in identifying and distinguishing user archive folders, especially when a user is authorized to access more than one user archive folder. Client profile information may also include a screen size for a particular hand-held device, language used on the hand-held device, whether the hand-held device supports color, the number of colors displayed on the hand-held device, and whether the device support JPG images.

File Processing

Once files are converted, compressed and encrypted on the desktop computer 210, the files are uploaded to the web server 220 where the files are processed by the file processor 250 for downloading to a hand-held device. The web server 220 stores uploaded files in a user archive file 222. Each user archive file 222 is associated with a specific user account that is accessed through a login procedure.

The file processor 250 decrypts encrypted archive files that are uploaded from the desktop computer 210. The file processor 250 decrypts files by performing the encryption process described above in reverse order. After decryption is complete, the file processor 250 decompresses the archive file and extracts individual files. The file processor 250 extracts page identifiers and file sharing information associated with each uploaded file. The file processor 250 also extracts the user's shared list, which may be uploaded with the files from the desktop computer 210. The shared list identifies other user accounts that are authorized to download the shared files from the user's archive file 222. The file processor 250 stores the uploaded files in the archive file associated with the user logged into the desktop computer 210. The shared list is stored in a database record associated with the logged in user.

The file processor 250 may update files on the web server 220 with files in the uploaded archive file. The file processor 250 compiles a list of file names in the user's archive file 222, and compares the list with the list of files uploaded from the desktop computer 210. The file processor 250 may also compare the list of file names in the user's archive file 222 with a list uploaded from the desktop computer 210 containing files to be deleted. Any files in the user's archive file 222 that are found to match files in either the list of uploaded files or the list of deleted files are deleted from the user's archive file. Then, all the files from the uploaded archive file are added to the user's archive file 222 so that the user's archive file contains updated versions of the files. Each file in the user's archive file may be manually updated anytime, but will only be automatically updated if an updating option was selected, for example, when the file was originally uploaded to the web server 220.

The system 200 may include a number of different components to control access to the user archive files 222 on the web server 220. The web server 220 in FIG. 2 includes a user authenticator 224 to verify that the user that accesses the web server has authorization to download and view files. A Digest Access Authentication Scheme is preferably used as specified by Internet standard RFC 2617. Instead of the MD5 digest algorithm described in the specification, the Secure Hash Algorithm-1 (SHA-1) is used to compute the hash function. Of the 160-bits returned by SHA-1, only the first 128 bits of the hash is used. For each request to the server 220, the authenticator 224 will compute a new authentication digest using the nonce value supplied by the previous server response.

User authentication may be carried out by associating each user with specific login information. For example, the user may be authenticated through the user's cell phone number and a pre-selected password. When the desktop client software is initially installed on the desktop computer, the user enters the phone number of the cell phone 230 that will receive files, and an account password. The account password is also entered on the cell phone 230 during installation of the client software on the phone. When a user logs on to the server 220 from the cell phone 230, the authenticator 224 identifies the cell phone and password information entered on the cell phone 230. The authenticator 224 then associates the password with the user's user archive file 222, and allows access to that user archive file. Upon a successful login from the cell phone 230, the server 220 sends a list of files on the user's archive file 222 to the cell phone 230. If the user's account includes client profile information, such as a user-friendly display name for the user archive folder, that is also sent to the cell phone. In addition, the server 220 sends a list of shared files from other user archive files if the user's account has access to the shared files. Files may be listed in a variety of formats on the cell phone. For example, assume that User A logs in to the system from a cell phone. If User A shares files with User B and User C, the server 220 can send a list of User A's files. The list also includes User B's archive folder and User C's archive folder. Selecting one of User A's files will download the selected file to the cell phone 230. Selecting User B's folder will retrieve a list of files in User B's folder that are shared with User A. Files in User B's folder that are not shared with User A will not be displayed on the phone. Selecting User C's folder will retrieve a list of files in User C's folder that are shared with User A. Files in User C's folder that are not shared with User A will not be displayed on the phone.

After the user is logged in, and has received the list of files in their user archive file, the user sends a request to the web server 220 to download a file to the cell phone 230. As described earlier, the files on the web server 220 were previously converted into a distilled format on the desktop computer 210, resulting in files that are small enough to be downloaded onto the cell phone 230. The web server 220 includes a file compressor 252 operable to compress a file selected for downloading. The file compressor 252 compresses the selected file to further reduce the size of the file being downloaded to the cell phone 230. This allows the file to be downloaded relatively quickly. The file compressor 252 may convert a file on the server 220 into a compressed file, such as a file in GZIP format. GZIP format is described in Internet standard RFC 1952. Once the selected file is compressed by the file compressor 252, a file encryptor 254 encrypts the file in the same manner in which files are encrypted prior to uploading to the server 220. The encrypted file is downloadable onto the cell phone 230.

File Viewing

The cell phone 230 includes a keypad 232, a video display 234 and an audio speaker 235. The keypad 232 allows the user to activate the phone client software and log in to the web server 220. The log in procedure may be automatically carried out by activating the phone client software on the phone 230. Alternatively, the log in procedure may be a manual procedure in which the user enters a password using the keypad on the phone 230. The cell phone 230 preferably supports Java™ applications and has a heap memory of at least 256 Kb.

Once the user is logged on to the web server 220, the display 234 conveys a list of files. The list contains files in the user's archive file, and shared files in folders from other accounts that share files with the user. If a user-friendly folder name was assigned to the user's archive folder on the web server, the display 234 will show a banner at the top of the file list that contains the user-friendly name. The display 234 prompts the user to select a file in the list for downloading. The keypad 232 may be used to select a file in the list for downloading. Once a file is downloaded to the cell phone 230, the file viewer 260 decrypts and uncompresses the file from the compressed format. The downloaded file may then be displayed or played on the cell phone 230.

The file viewer 260 may be used to view several page files in sequential order. The user can move from one page file to next page file by entering commands on the key pad 232 of the cell phone 230. The file viewer 260 may display small labels (commonly referred to as “softkeys”) on the display screen 234 directly above buttons on the key pad 232. The softkeys are labeled with a specific function that will be performed when the adjacent button is pressed. For example, the file viewer 260 may display a “Next” softkey which is configured to move from one page file to the next page file in a document file. The “Next” softkey may be positioned in the lower-right corner of the display screen 234, immediately above a button on the upper right corner of the keypad 232. By pressing the button on the upper right corner of the keypad 232, the user operates the “Next” softkey. In response, the file viewer 260 removes the page file being displayed on the screen 234 and displays the next subsequent page file downloaded to the cell phone 230. The file viewer 260 may also display a “Back” softkey that allows the user to return to the page-select list previously shown on the display screen.

The file viewer 260 may be configured to download one or more page files in addition to the page file selected by the user of the cell phone 230. In particular, the file viewer may download an additional page file that immediately precedes or follows the selected page file. This feature, referred to as “prefetching” is based on the high probability that a user who sends a request to the web server 220 for a particular page file will send additional requests for page files that precede or follow the downloaded page file. Prefetching provides a smoother download process that decreases the perceived waiting time when moving from one page file to the next.

The prefetching feature operates in the following manner. When a user selects a page file from a file list, the file viewer 260 downloads the selected page file along with the next page file in the file list. When downloading of the selected page file is complete, the selected page file is displayed on the screen 234, and the next page file is then downloaded and stored in memory on the cell phone 230. When the user enters a command to move to the next page (such as pressing the “Next” softkey), the next page file is retrieved from memory on the cell phone and immediately displayed, rather than being downloaded from the web server. At the same time, the file viewer 260 downloads the next page file from the web server and stores it in memory on the cell phone. The process is repeated each time a file is selected for downloading from the web server. The prefetching feature allows successive pages to be retrieved relatively quickly from the cell phone's memory, preventing long wait times between pages.

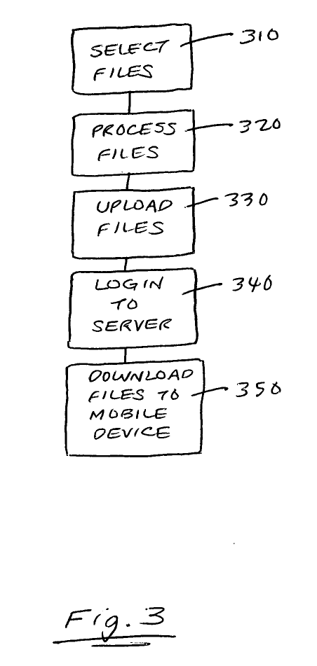

Referring now to FIGS. 3-6, the method steps for downloading files from a data storage device and viewing the files on a hand-held device are illustrated. FIG. 3 provides an overview of a process for transferring files from a data storage device to a hand-held device. The user begins by selecting files on the data storage device in step 310. The data storage device may be a desktop computer, laptop computer, or other data storage device having an Internet connection, as mentioned above. For purposes of this description, it will be assumed that the data storage device is a desktop computer. When the selected file is added to the file folder, the client software processes the file in step 320. The file is processed into a format that decreases the amount of data that will ultimately be downloaded onto the hand-held device. Once the file is processed on the desktop computer, the file is uploaded to the web server in step 330. The file is stored in a user archive file on the web server. A user of a hand-held device logs in to the web server in step 340 to gain access to the user archive file where the uploaded file is stored. Once the hand-held device is logged in to the server, the file is selected and downloaded to the hand-held device in step 350.

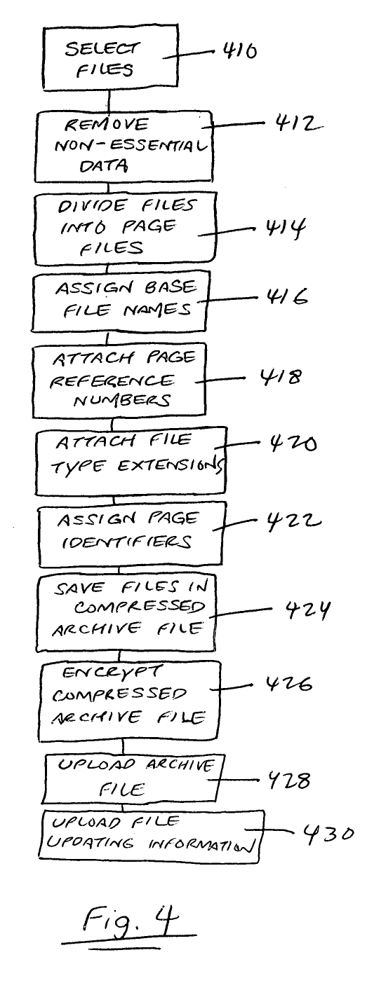

FIG. 4 illustrates steps for processing and uploading files on the desktop computer in greater detail. Files on the desktop computer are selected for uploading in step 410. The files are selected using the client software installed on the desktop computer. The software may operate in a variety of ways to allow the user to select files. For example, after the client software is started, the software may open a window (herein referred to as an “Add Window”) that displays a file folder. The file folder in the Add Window contains files that are chosen by the user to be processed and uploaded to the web server. A drop down menu may also be provided that includes an “Add” menu item. Upon selecting the “Add” menu item, the software opens a dialog box that allows the user to search for files stored on the desktop computer. The dialog box also allows the user to search for files on a shared network, internal disk drive, or external device, such as a digital camera or zip drive. Files that are selected in the dialog box are copied into the folder in the Add Window.

As an alternative, files may be selected using a drag-and-drop method. In this method, a separate folder containing the file is opened on the same screen as the Add Window. The file's icon is selected with the mouse button and “dragged” into the Add Window. Upon dragging the icon into the Add Window, the file is added to the folder.

When the selected file is added to the file folder, the client software converts the file into a distilled file. The file is converted to remove non-essential data in step 412, such as non-essential formatting data. The file conversion decreases the amount of data that is uploaded to the web server and ultimately downloaded onto the hand-held device. Larger files are separated into individual pages, with each page saved as a separate page file in step 414. Each page file is assigned with a specific base file name in step 416 that corresponds to the file name of the original file. The software then attaches a reference number at the end of the base file name of each page file in step 418. The reference number indicates the order and position of the page file in the original file, relative to other page files. The software also attaches a file type extension to the page file name in step 420 that indicates the type of application that runs the program. If applicable, the software attaches a page identifier to each page file in step 422.

Once the selected file or files are converted, the converted files are saved in a compressed archive file, such as a ZIP archive file, in step 424. The ZIP archive file format is a compressed archive that supports multiple archived files and comment fields for each file. The comment fields may contain the page identifiers for page files. After the files are saved in the compressed archive file, the software encrypts the compressed archive file in step 426.

The software on the desktop computer uploads the encrypted archive file to the web server in step 428. If the file is to be shared, the desktop computer uploads file sharing information to be used by the web server to provide access to shared users who log on to the server. The software will also upload file updating information in step 430, to the extent that files stored on the server have been modified since the time they were uploaded or last updated.

The user may use the Add Window to delete files that were previously uploaded to the web server. As mentioned earlier, this may be desirable when the user uploads a file to the web server and subsequently deletes the same file from the desktop computer. The user may select the file in the Add Window to remove or delete the file from the web server. The selected file is then added to a list of files to be deleted. The list is subsequently uploaded to the web server, which deletes the file from the user's archive file.

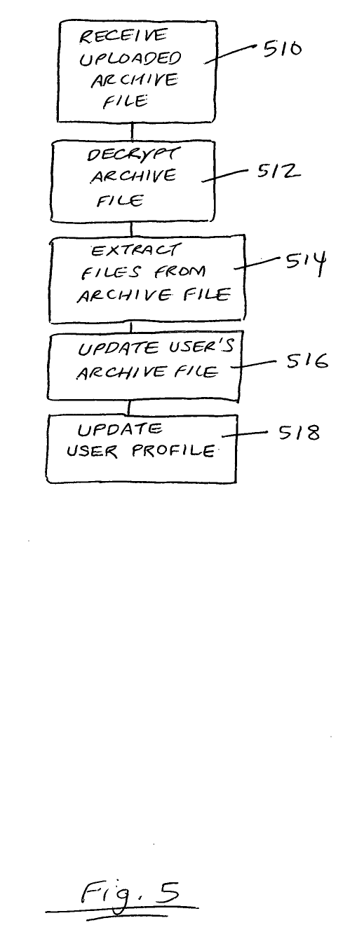

FIG. 5 illustrates steps for processing files on the server that are uploaded from the data storage device. The server receives uploaded files in step 510. The files are uploaded in an encrypted and compressed archive format. The server software decrypts the uploaded archive file in step 512. After the archive file is decrypted, the server software extracts files from the compressed archive file in step 514. The server extracts file information, including the individual page files and page identifiers associated with each page file. The server then updates the user's archive file in step 516. Files in the user's archive file that match files in the uploaded archive file are removed and replaced with the uploaded file. If the page file is unchanged but the page identifier has changed, the page identifier will be replaced. If the user also uploaded a list of files to be deleted, the server will identify the listed files in the user's archive file and delete them. The server may also receive file sharing information and update the user's profile in the user database in step 518.

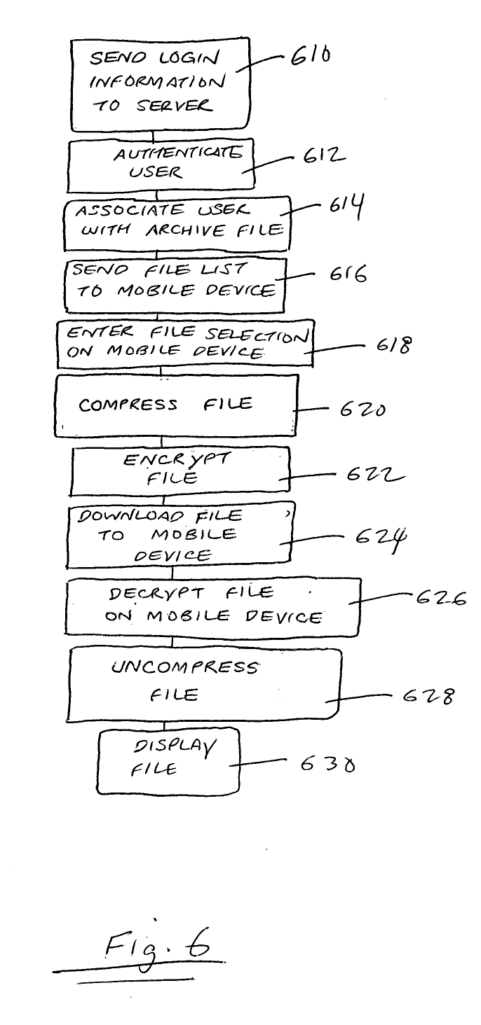

FIG. 6 illustrates steps for accessing the web server from a hand-held device and downloading files from the web server onto the hand-held device. The hand-held device sends login information to the web server in step 610. The login information may be entered manually by the user of the hand-held device, or it may be automatically sent by client software on the hand-held device. The web server receives the login information and authenticates the user of the hand-held device in step 612. The web server then accesses the user archive file associated with the user in step 614. All files and associated page files are extracted from the user archive file and compiled into a list. The web server then sends the file list to the hand-held device in step 616.

The hand-held device receives and displays the file list to the user of the hand-held device. The list may be displayed in discrete pages, or as a single list which the user can scroll down. The user of the hand-held device uses the keypad to toggle between pages on the list, or scroll down the list, as necessary. Once the user finds a file to view, the user uses the key pad to enter their file selection in step 618. If the selected file is divided into multiple page files, a list of page files will be displayed, allowing the user to select individual page files for viewing. Once a file selection is made, the hand-held device sends the file selection to the web server.

The web server receives the file selection and extracts the file from the user archive file. The selected file, which was previously converted into a distilled file on the data storage device, is compressed in step 620. The distilled format of the file, combined with the file compression, reduces the amount of data downloaded to the hand-held device, thereby decreasing downloading time. The smaller amount of data also lowers the amount of fees paid to cell phone service carriers who charge users for transferring data on a per-kilobyte basis. After the selected file is compressed, the web server software encrypts the compressed file in step 622. The encrypted file is then downloaded to the hand-held device in step 624. The hand-held device receives the encrypted file and decrypts the file in step 626. The hand-held device then uncompresses the file in step 628 and displays or plays the file in step 630.

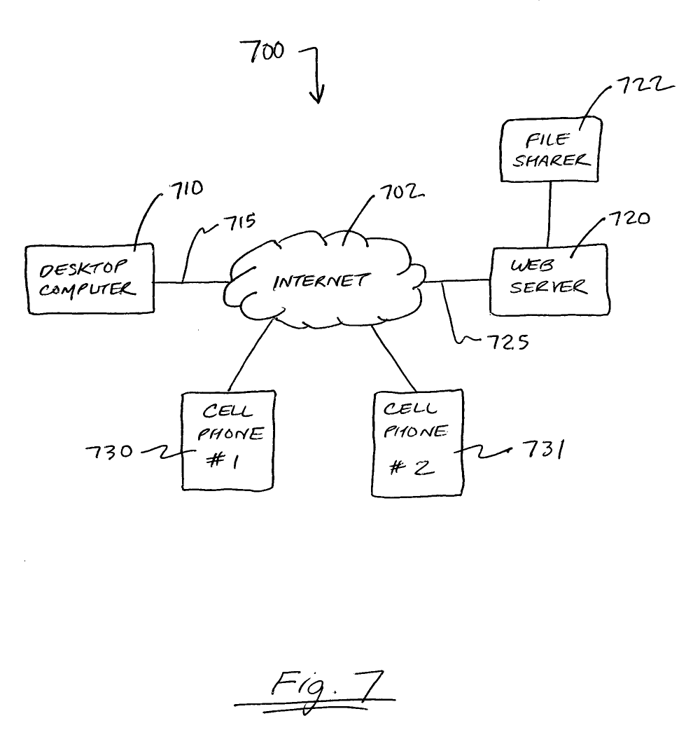

In some applications, it may be desirable to share files with a hand-held device that does not have the client software installed. For this purpose, the system of the present invention is adapted to share files with hand-held devices that do not have the client software installed. Referring to FIG. 7, an alternate system 700 is shown which features a first cell phone 730 with client software installed, and second cell phone 731 without client software installed. The system 700 includes a desktop computer 710 connected with the Internet 702 by an Internet connection 715. A web server 720 communicates with the desktop computer 710 through the Internet connection 725, allowing files on the desktop computer to be uploaded to the web server.

The system 700 allows the user of the first cell phone 730 to access the web server 720 and transfer files to the second cell phone 731. The web server 720 includes a file sharer 722 that processes a selected file for downloading the file to the second cell phone 731. The files that are delivered to the second cell phone 731 are viewed through the second cell phone's web browser. To use the system, a user logs on to the web server 720 from the first cell phone 730. The user then selects one or more files on the web server 720 that the user desires to share with the second cell phone 732. The user also provides the phone number for the second cell phone 731. The file sharer 722 adds an entry in a database containing information about the shared file and sends a URL link to the first cell phone 730. The URL link contains a unique reference number that refers to the database entry for the shared file. The client software on the first cell phone 730 sends a Short Message Service (SMS) message or instant message to the second cell phone 731 which contains the name of the shared file and the URL link. The user of the second cell phone 731 can download the shared file from the URL link using the browser on the second cell phone.

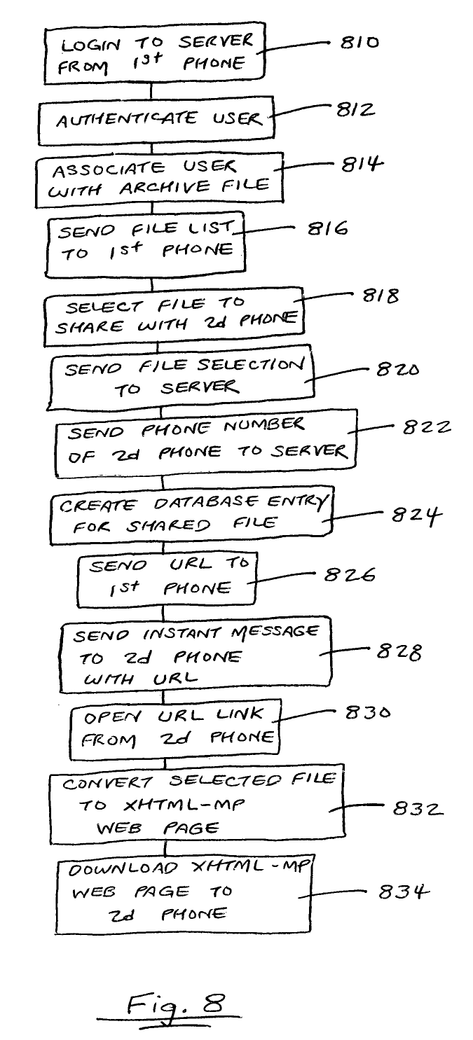

FIG. 8 illustrates steps for using a first cell phone with client software to share files with a second cell phone that does not have client software. The user of the first cell phone logs into the web server in step 810. The web server receives the login information and authenticates the user of the first cell phone in step 812. The web server then accesses the user archive file associated with the user in step 814. All files and associated page files are extracted from the user archive file and compiled into a list. In addition, any shared files from other archive files on the server are extracted and added to the list. The web server then sends the file list to the first cell phone in step 816.

The first cell phone receives and displays the file list. The user of the first cell phone surveys the list and selects a file that the user wishes to share with the second cell phone in step 818. The file selection is entered on the first cell phone and sent to the web server in step 820. In addition, the phone number for the second cell phone is entered on the first cell phone and sent to the web server in step 822. The web server creates a database entry for the shared file in step 824. The database entry includes a unique identification number assigned specifically to the file share request. The database entry also includes the file name associated with the selected file, and the phone number for the first cell phone. The server then creates a URL link that includes the identification number contained in the database entry. The web server sends the URL link to the first cell phone in step 826. The client software on the first cell phone sends a Short Message Service (SMS) message or instant message to the second cell phone in step 828. The instant message contains the name of the shared file and the URL link. The user of the second cell phone then downloads the shared file by opening the URL link on the second cell phone's browser in step 830. The web server uses the identification number attached to the URL to look up the shared file in the server's database of shared file information. The file sharer on the web server extracts the shared file from the archive file where it is stored and converts the shared file to a web page in step 832. The web page is written in extensible HyperText Markup Language-Mobile Profile (XHTML-MP). The XHTML-MP web page is then downloaded to the second cell phone in step 834.

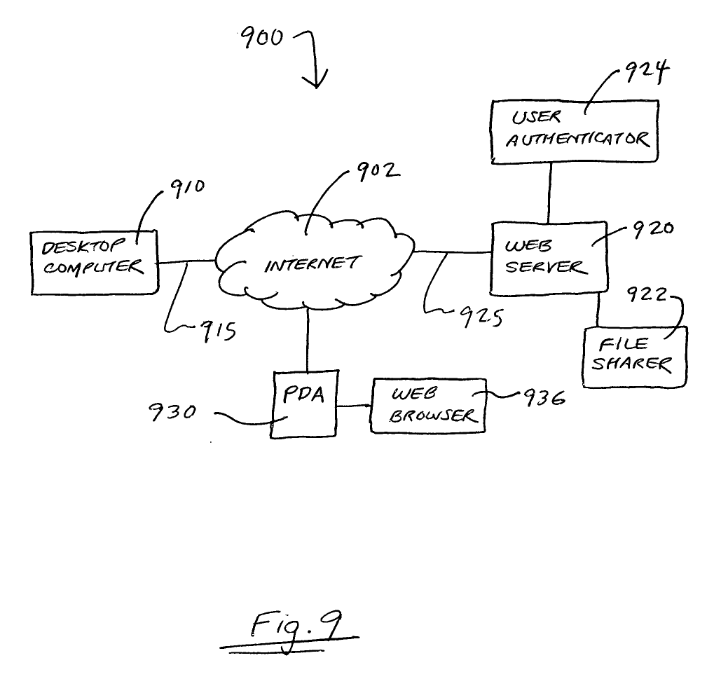

A person may desire to access a file from a cell phone that does not have client software installed, under circumstances in which file sharing with another cell phone is not possible or available. For this purpose, the system of the present invention can be used to download and view files on a hand-held device without client software installed on the device. Files can be downloaded on almost any hand-held device that has a web browser and Internet connection. Referring to FIG. 9, a system 900 includes a desktop computer 910, a web server 920 and a PDA 930 that does not have any client software installed. The desktop computer 910 is connected with the Internet 902 by an Internet connection 915. A web server 920 is also connected with the Internet 902 by an Internet connection 925 and communicates with the desktop computer 910, allowing files on the desktop computer to be uploaded to the web server.

The PDA 930 is connected with the Internet 902 by an Internet connection 935. The PDA 930 has a built-in web browser 936 for accessing the web server 920. The browser 936 displays pages written in XHTML-MP. The user navigates the web browser 936 to the web server 920 and opens a web page. The web page contains instructions for entering login information from the PDA 930. Login information may include a name or account number, and a password or other user-associated information. The web server 920 includes a user authenticator 924 to verify that the login information is correct. If the login information is found valid, the web server 920 sends a list of hyperlinks to the PDA 930. Each hyperlink corresponds to a specific file in the user's archive file, or a folder representing shared files stored in another user's archive file. The user may select a hyperlink to download and view the contents of a file associated with the hyperlink. If the hyperlink corresponds to a file composed of multiple pages, the hyperlink will retrieve a list of hyperlinks corresponding with page files. Each page file hyperlink can be selected to download and view a specific page. When a hyperlink is selected on the PDA 930, the web server 920 converts the file into an XHTML-MP web page and downloads the web page to the PDA where it is displayed.

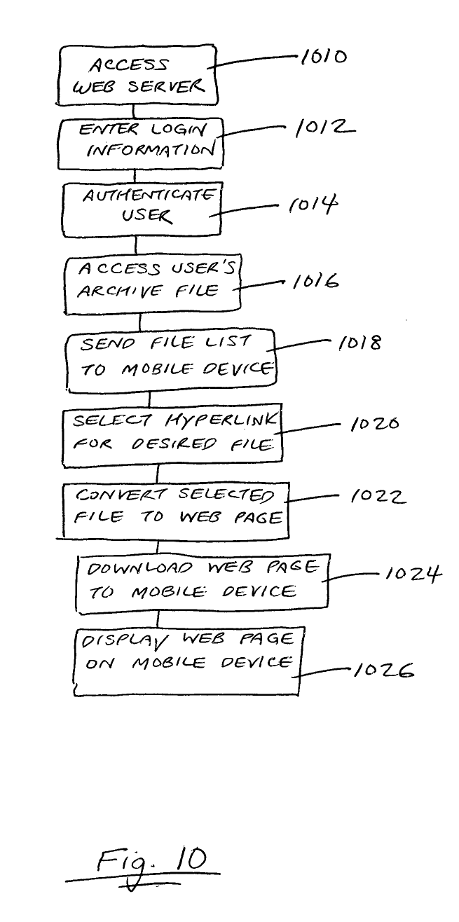

FIG. 10 illustrates steps for downloading files from a web server to a hand-held device using the hand-held device's web browser. The user of the hand-held device accesses the web server through the web browser in step 1010. The hand-held device receives a web page that is viewable on the display screen on the hand-held device. The web page contains instructions and a prompt for entering login information. The user enters the required information and sends it to the web server in step 1012. The web server receives the login information and authenticates the user of the hand-held device in step 1014. The web server then accesses the user archive file associated with the user in step 1016. All files and associated page files from the user's archive file are extracted and compiled into a list of hyperlinks. In addition, all shared folders to which the user has access are added to the list of hyperlinks. Each hyperlink in the list is associated with a specific file or shared folder. If the hyperlink corresponds to a shared folder, the hyperlink will open a list of additional hyperlinks, each corresponding to a shared file. The server sends the list of hyperlinks to the hand-held device in step 1018, and the hand-held device displays the list to the user. The user then selects a hyperlink in step 1020 to download and view a specific file. If the hyperlink corresponds to a file having multiple pages, the hyperlink will open a list of additional hyperlinks, each corresponding to a page file. Each page file hyperlink can be selected to download and view a specific page in the file. When a file is selected for downloading, the web server converts the file into an XHTML-MP web page in step 1022. The web server then downloads the web page to the hand-held device in step 1024. The web page is then displayed on the hand-held device in step 1026.

The terms and expressions which have been employed are used as terms of description and not of limitation. There is no intention in the use of such terms and expressions of excluding any equivalents of the features shown and described or portions thereof. It is recognized, therefore, that various modifications are possible within the scope and spirit of the invention. Accordingly, the invention incorporates variations that fall within the scope of the following claims.

I claim:

1. A method for sharing files on a data storage device with a hand-held device, comprising the steps of:
A. selecting a file on the data storage device to be shared with the hand-held device;
B. processing the selected file on the data storage device into a converted file for uploading to a web server;
C. uploading the converted file to the web server;
D. accessing the web server from the hand-held device; and
E. sending the converted file to the hand-held device for displaying or playing on the hand-held device.

2. The method of claim 1 wherein the step of processing the selected file on the data storage device into a converted file comprises the step of converting the selected file into a format supported by the hand-held device.

3. The method of claim 1 wherein the step of processing the selected file on the data storage device into a converted file comprises the step of saving the file in a compressed file archive.

4. The method of claim 1 wherein the step of processing the selected file on the data storage device into a converted file comprises encrypting the selected file.

5. The method of claim 1 comprising the step of saving the converted file into a user archive file on the web server, said user archive file being associated with a specific user account.

6. The method of claim 5 wherein the step of saving the converted file into a user archive file on the web server comprises the step of extracting the converted file from a compressed format.

7. The method of claim 5 wherein the step of saving the converted file into a user archive file on the web server comprises the step of decrypting the converted file.

8. The method of claim 1 wherein the step of accessing the web server from the hand-held device comprises the step of sending login information to the web server from the hand-held device.

9. The method of claim 1 comprising the step of compressing the converted file on the web server prior to the step of sending the converted file to the hand-held device.

10. The method of claim 1 comprising the step of sending a file list to the hand-held device, said file list identifying one or more files on the web server that are available for downloading to the hand-held device.

11. The method of claim 1 comprising the step of updating files in the user archive file.

12. The method of claim 11 wherein the step of updating files in the user archive file comprises the steps of:
A. identifying a file on the data storage device that was previously uploaded to the web server;
B. verifying that the file on the data storage device was modified after it was uploaded to the web server; and
C. uploading a modified file to the web server to replace the prior uploaded version.

13. The method of claim 11 wherein the step of updating files in the user archive file comprises the steps of:
A. identifying a file that was previously uploaded to the web server;
B. verifying that the file was deleted on the data storage device since being uploaded to the web server;
C. uploading information about the deleted file to the web server; and
D. removing the deleted file from the user archive file on the web server.

14. The method of claim 1, wherein the steps of selecting a file and processing the file into a converted format comprise the steps of selecting a word processing document and dividing the word processing document into a plurality of pages, each of said pages being saved as a separate page file.

16. The method of claim 15, wherein each page file comprises a plurality of blocks, each block comprising text associated with a set of text attributes.

17. The method of claim 16, wherein the text attributes comprise at least one of bold, italic, underline, double underline, strikethrough, align left, align center, align right, wrap text, table, align top, align middle, align bottom, foreground color and background color.

18. A system for sharing a file stored on a data storage device with a hand-held device, said data storage device being connected in communication with a web server, said system comprising:
A. a file converter associated with the data storage device, said file converter being operable to convert the file to a distilled file and upload the distilled file to the web server;
B. a file processor associated with the web server, said file processor being operable to process the distilled file uploaded from the data storage device and send the distilled file to the hand-held device for viewing; and
C. a file viewer associated with the hand-held device, said file viewer being adapted to download the distilled file from the web server and display or play the distilled file on the hand-held device.

19. The system of claim 18 wherein the data storage device comprises a desktop computer, and the file converter is installed on the desktop computer.

20. The system of claim 18 wherein the file viewer is installed on the hand-held device.

21. The system of claim 18 comprising a file synchronizer operable to update files on the web server with files on the data storage device.

22. The system of claim 18 comprising a file synchronizer operable to send a list of files deleted from the data storage device to the web server, and instruct the file processor to delete files stored on the web server that are identified on said list of files deleted from the data storage device.

23. The system of claim 18 comprising a file sharer operable to create a URL link from which the distilled file can be downloaded through an Internet connection.

24. The system of claim 18 comprising a user authenticator.

25. The system of claim 18 comprising a file compressor operable to convert the distilled file into a compressed file.

26. The system of claim 25 comprising a file encryptor operable to encrypt the compressed file.

27. The system of claim 18 comprising a plurality of user archive files on the web server, each user archive file associated with a user authorized to access the web server and download files from the server.

28. The system of claim 27 comprising a plurality of shared files stored in the user archive files.

29. The system of claim 18 wherein the file converter is operable to convert the distilled file into a plurality of page files for uploading to the web server.

30. The system of claim 29 comprising a file compressor operable to compress said plurality of page files into a compressed archive file for uploading to the web server.

31. The system of claim 30 wherein the file processor is operable to extract the plurality of page files from the compressed archive file and store the extracted page files in a user archive file on the web server.

32. The system of claim 31 wherein the file viewer is operable to access the web server and download a list of the page files stored in the user archive file.

33. The system of claim 32 wherein the file viewer is operable to select a page file in the list for downloading to the hand-held device.

34. The system of claim 33 wherein the file processor is operable to download the selected page file to the hand-held device.

35. The system of claim 34 wherein the file viewer is operable to download the selected page file simultaneously with the next page file appearing in the list, said file viewer being operable to display the selected page file and store the next page file in memory on the hand-held device.

36. The system of claim 18 wherein the file converter is operable to process the selected file on the data storage device by stripping nonessential formatting attributes from the selected file.

37. A system for downloading and viewing files on a mobile device, comprising:
A. a data storage device containing one or more files in memory, said data storage device having access to the Internet;
B. a server in operable communication with the data storage device through an Internet connection established on the data storage device;
C. a file converter operable to process a selected file on the data storage device into a distilled file, said file converter being operable to upload the distilled file to the server;
D. a file processor operable to receive the distilled file uploaded from the data storage device;
E. a hand-held device having access to the Internet; and
F. a file viewer on the hand-held device adapted to access the server through an Internet connection established on the hand-held device, said file viewer being operable to display or play the distilled file on the hand-held device.

38. The system of claim 37 wherein the data storage device comprises a desktop computer with a wireless Internet connection.

39. The system of claim 37 wherein the file converter is operable to process the selected file into a plurality of distilled files, each distilled file representing one page from the selected file and being stripped of nonessential formatting attributes that were in the selected file.

40. The system of claim 37 wherein the selected file comprises an ASCII text file, a word processing document, a spreadsheet, an image file, a presentation file, a movie file, or an audio file.

41. The system of claim 37 wherein the selected file comprises a word processing document and the distilled file comprises one or more blocks containing text and one or more text attributes.

42. The system of claim 41 wherein each block is configured to include a block of data, one or more attribute codes assigned to said block of data, and a separator to separate said block of data from said one or more attribute codes.

43. The system of claim 37 wherein the selected file comprises an image file and the distilled file comprises a file in Portable Network Graphics (PNG) format or Joint Photographic Experts Group (JPG) format.

44. The system of claim 37 wherein the selected file comprises a spreadsheet file and the distilled file comprises one or more blocks containing text and one or more text attributes.

45. The system of claim 44 wherein each block includes a block of data and one or more attribute codes assigned to the block of data.

46. The system of claim 37 wherein the selected file comprises a presentation file having a plurality of slide images, said file converter being operable to convert the presentation file into one or more files in PNG format, each PNG file containing an image of one of said slides in the presentation file.

47. The system of claim 46 wherein the one or more PNG files each comprise a page identifier corresponding to a title used on a slide in the presentation file.

48. The system of claim 37 comprising a file compressor operable to compress the distilled file into a compressed format prior to uploading the distilled file to the server.

49. The system of claim 37 comprising a file encryptor operable to encrypt the distilled file prior to uploading the distilled file to the server.

50. The system of claim 37 wherein the file converter is operable to process the selected file on the data storage device by stripping nonessential formatting attributes from the selected file.

51. A system for downloading and viewing files on a mobile device, comprising:
A. a data storage device containing one or more files in memory, said data storage device having access to the Internet;
B. a server in operable communication with the data storage device through an Internet connection established on the data storage device;
C. a file converter operable to process a selected file on the data storage device into a distilled file, said file converter being operable to upload the distilled file to the server;
D. a file sharer operable to convert the distilled file on the server to a web page; and
E. a hand-held device comprising an Internet connection, said hand-held device having a file viewer adapted to download the web page through the Internet connection.

52. The system of claim 51 comprising a first cell phone operable to select a file on the server for sharing with the hand-held device.

53. The system of claim 52 wherein the hand-held device comprises a second cell phone having a web browser.
